(19) United States
(12) Patent Application Publication
(10) Pub. No.: US 2014/0009584 A1
(43) Pub. Date: Jan. 9, 2014

(54) DEVICE AND METHOD FOR THE OPTICAL 3D MEASUREMENT OF SURFACES

(71) Applicants: Tilo Lilienblum, Magdeburg (DE); Wolfram Schmidt, Stadt Falkenstein (DE)

(72) Inventors: Tilo Lilienblum, Magdeburg (DE); Wolfram Schmidt, Stadt Falkenstein (DE)

(21) Appl. No.: 13/979,418

(22) PCT Filed: Oct. 11, 2011
(86) PCT No.: PCT/DE11/50045

§ 371 Date: Sep. 11, 2013

(30) Foreign Application Priority Data
Jan. 14, 2011 (DE) 10 2011 008 655.2

(51) Int. Cl. G01B 11/25

(52) U.S. Cl. CPC G01B 11/2545
USPC 348/46

(57) ABSTRACT

A device for three-dimensional optical measurement of surfaces of arbitrary objects (2) using a pattern projection method, with a projector (3) for projecting patterns onto the surface (1) of the object (2), at least one camera (5) or imaging unit for recording the projected pattern and a computer for processing the image information recorded by the camera or the imaging unit to form 3D data, optionally for three-dimensional imaging of the object (2), is characterized in that the projector (3) only emits narrowband light and in that a filter apparatus is arranged in the detection beam path in front of the camera (5) or imaging unit, which filter apparatus is only transmissive to the wavelength range of the light emitted by the projector (3). A method application of the device according to the invention has a corresponding design.

### FIELD

The invention relates to a device for three-dimensional optical measurement of surfaces of arbitrary objects using a pattern projection method (in particular a strip-projection method), with a projector for projecting patterns onto the surface of the object, at least one camera for recording the projected pattern and a computer for processing the image information recorded by the camera to form 3D data, optionally for three-dimensional imaging of the object. Furthermore, the invention relates to a corresponding method, which uses the device according to the invention.

### BACKGROUND

It should be noted that, in principle, this relates to the use of a pattern projection method, wherein the term “pattern” should be understood in the broadest possible sense. By way of example, sinusoidal patterns within the scope of phase-shifting methods, radial patterns for radially symmetric parts or partial patterns for avoiding an illumination of interfering reflecting surface parts, inverse patterns, etc. can be subsumed by this term.

The pattern projection method, in particular the strip-projection method, sometimes also referred to as strip-light topometry, comprises a group of optical measurement methods, according to which image sequences are used for three-dimensional capture or measurement of surfaces. This method requires a pattern projector and at least one camera or imaging unit, for example an analog or digital video camera.

During the measurement, the projector illuminates the measurement object sequentially in time with patterns of parallel bright and dark regions or strips with equal or varying width. The camera or cameras registers or register the projected pattern at a known position and a known angle in relation to the projection. At least one image is recorded by the camera for each projection pattern. A temporal sequence of different brightness values is created for each pixel of the cameras. The three-dimensional coordinates of the surface to be imaged is usually calculated in two steps. For a given object point, the image coordinates in the camera image are known. It is possible to calculate the specific strip from the sequence of brightness values, which were measured or detected from the image sequence for each camera pixel. In the simplest case, this is brought about by binary code, which characterizes the number of the strip as discrete coordinate in the projector. A higher accuracy can be achieved with the so-called phase shifting method, according to which a non-discrete coordinate can be determined.

The strip number in the projector corresponds to the image coordinate in the camera. It specifies a light plane in space; the image coordinate specifies a light beam. If the camera and projector position are known, the intersection of the plane and the straight line can be calculated. This results in the three-dimensional coordinate of the object point in the coordinate system of the sensor. The geometric position of all image beams is assumed to be known. The precise calculation of the beams is generally brought about using the forward section known from photogrammetry.

A precondition for correct calculation of the coordinates is a precise calibration of the imaging properties. Moreover, it is essential that the strip-projection sensor can only capture the visible part of a surface, namely that part which is illuminated by the projector and can be observed by the camera or cameras. Hidden regions must be made visible from a different angle.

A number of imaging methods have been disclosed in practice, in which three-dimensional data are generated with the aid of a projection unit and one or more cameras. Reference is made, merely in an exemplary manner, to U.S. Pat. No. 6,542,250 B1.

Devices which operate according to the known method comprise a so-called pattern projector (in particular a line projector) and one or more cameras. The patterns (e.g. lines) to be projected are regularly projected onto the surface of the object using projectors specifically developed for optical 3D measurements. Halogen lamps, gas discharge lamps or LED lamps are usually used as illumination.

Furthermore, it is known from practice to use flash lamps for eliminating stray light. The flash is synchronized with the respective camera.

It is also already known from practice to use a narrowband light source and to separate the projected light from stray light with the aid of a filter in front of the camera. In this respect, reference is made to U.S. Pat. No. 5,175,601. In this respect, there is already filtering of the monochromatic laser light for the strip projection here.

It is moreover known from practice to filter out directly reflected light by projecting polarized light and using pole filters in front of the lenses.

The devices and methods known from practice are problematic to the extent that the application of the strip-light projection is complicated both in generating the strip light or the lines and in detecting the light of interest while avoiding directly reflected light. Moreover, carrying out corresponding methods is problematic since stray light must always be eliminated by complicated measures. Illumination which is significantly more intensive than the surrounding light is regularly selected. Flashlight and the corresponding synchronization with the camera are required for image recording. It is not uncommon for the measurement arrangement to be completely darkened in order to eliminate the aforementioned problems.

The present invention is therefore based on the object of specifying both a device and a method for three-dimensional optical measurement of surfaces of arbitrary objects, according to which the strip-projection method can be applied in a simple fashion while eliminating the otherwise common disadvantages.

### SUMMARY OF THE INVENTION

The device according to the invention for three-dimensional optical measurement of surfaces of arbitrary objects using strip-projection methods achieves the aforementioned object by the features of Patent claim 1. According to this, the generic device is characterized in that the projector only emits narrowband light and in that a filter apparatus is arranged in the detection beam path in front of the camera, which filter apparatus is only transmissive to the wavelength range of the light emitted by the projector.

The device according to the invention is characterized by the features of coordinate Patent claim 16, namely by virtue of the fact that only narrowband light is emitted by the projector and that use is made of a filter apparatus in the detection beam path in front of the camera, which filter apparatus is only transmissive to the wavelength range of the light emitted by the projector.

According to the invention, it was identified that the strip-projection method can be applied without problems if the projector for illuminating the surface of the respective object has specific properties in relation to the illumination light, namely if it only emits narrowband light. The camera or the camera system is adapted accordingly, namely by virtue of the fact that a filter apparatus is arranged in the detection beam path in front of the camera, which filter apparatus is only transmissive to the wavelength range of the light emitted by the projector. The camera or the filter apparatus associated with the camera is therefore matched to the band range of the light source of the projector.

In accordance with the invention, a device is realized which enables an areal measurement according to the strip-projection method. Advantageously, the projector utilized thereby is a commercially available video projector, which has been modified or redesigned for projecting narrowband light. This redesigned video projector can be ideally employed for the pattern projection.

The method according to the invention is designed accordingly, with the latter being less dependent upon stray light than the methods previously known from practice, namely by employing the device according to the invention.

The projector is particularly advantageously equipped with a monochromatic light source, preferably a laser light source. The projector is designed in such a way that it only emits the light from this light source. It should be noted here that a laser light source is particularly suitable, but other monochromatic light sources can also be used.

The monochromatic light source advantageously emits coherent light. More precisely, the monochromatic light source can preferably emit linearly polarized light, as a result of which the advantages explained below, in particular in relation to correspondingly designed camera systems, emerge.

As already mentioned previously, the projector can be a—cost-effective—commercially available video projector. It can be freed from those components/functional groups which serve to generate a broadband light spectrum, i.e. to generate the basic colors red, green and blue. Alternatively, it is feasible for these components/functional groups within the video projector to be switched off or deactivated. In a merely exemplary fashion, reference is made to a specific projector by Casio, type XJ-A, with the redesign there substantially being realized by removing the color wheel from the beam path and by switching off the red LED light source. Other commercially available projectors can be modified accordingly and can be used after the modification.

It is also feasible for a Gaussian blur filter and/or a diffractive element to be arranged in front of the projector. As a result, the projected patterns obtain unsharpness which can be defined by the filter or the diffractive element, independently of the focusing setting of the projector.

With respect to the camera, it is essential that it can in each case be a camera system with an upstream band-pass filter, namely with a band-pass filter in front of the optical unit of each camera, with the filter only being transmissive to the wavelength range generated by the monochromatic light source. Thus, the filter apparatus in front of the camera can comprise one or more band-pass filters, one or more pole filters or a combination of band-pass filters and pole filters. Within the scope of such an embodiment, the assumption can be made that the monochromatic light source, e.g. a laser light source, generates linearly polarized light. The pole filter in front of the camera or in front of the cameras can advantageously be set in such a way that only diffusely reflected light is passed. As a result, interference by direct reflections can be suppressed in the case of certain materials, e.g. in the case of surfaces made of plastic.

Within the scope of a further special embodiment, it is feasible for the filter apparatus to be designed in such a way that it has several pass regions. This can be achieved by virtue of the fact that the filter apparatus comprises a special filter or combination of several filters. This is advantageous if the light source of the projector emits several frequency bands, for example when using gas discharge lamps. It is also possible that the projector could be redesigned in such a way that several light sources are employed for the projection, optionally where possible. Then it is also advantageous if the filter apparatus has several—preferably selectable—pass regions.

It was mentioned previously that the camera system can comprise several cameras, wherein it is furthermore advantageous if, with their optical axes, the cameras are aligned at different angles to the surface of the object to be measured. In this respect, improved optical scanning of the surface is possible, particularly in the case of strongly structured surfaces.

A specific situation emerges in the case of stereo recordings, according to which it is not, for example, intersections of a visual beam of the camera with the light plane of the projector that are used for reconstruction; the illumination rather provides corresponding pixels of the two cameras by correlating the various intensities such that, for example, a reconstruction can take place via points with the shortest distance to the two visual beams of the camera. In respect of the method underlying this, reference is made to U.S. Pat. No. 6,542,251 B1.

Moreover, with respect to the usable cameras, reference is made to the fact that a line camera system can also be employed.

The strip light required for applying the strip-projection method can be generated in different ways, for example by a slide, an LCD display, an LCOS display or a DLP chip. Any type of strip-light generation is feasible.

The method according to the invention advantageously employs the device according to the invention, and so, in order to avoid repetition, reference can be made to the explanations in respect of the device according to the invention.

### BRIEF DESCRIPTION OF THE DRAWINGS

There are now various options for advantageously designing and developing the teaching of the present invention. In this respect, reference is made firstly to the patent claims following Patent claim 1 and secondly to the following explanations, based on the drawing, of a preferred exemplary embodiment of the invention. In conjunction with the explanations of the preferred exemplary embodiment of the invention on the basis of the drawing, preferred refinements and developments of the teaching are also explained in general terms. In the drawing:

FIG. 1 shows, in a schematic view, the basic arrangement of the respective functional elements of a device according to the invention for applying the method according to the invention and

FIG. 2 shows, in a schematic view, the basic design of a camera as a component of a device according to the invention.

### DETAILED DESCRIPTION OF THE INVENTION

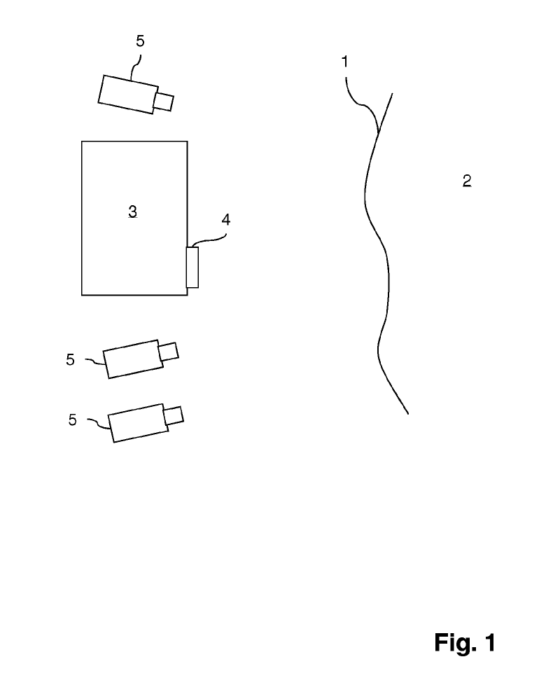

FIG. 1 shows the basic arrangement of an exemplary embodiment of a device according to the invention, wherein the latter serves for the three-dimensional optical measurement of the surface 1 of an object 2. A redesigned commercially available video projector 3 serves for projecting a pattern onto the surface 1 of the object 2. A Gaussian blur filter 4 is symbolically indicated in front of the video projector 3, namely in front of the optical unit of the video projector 3.

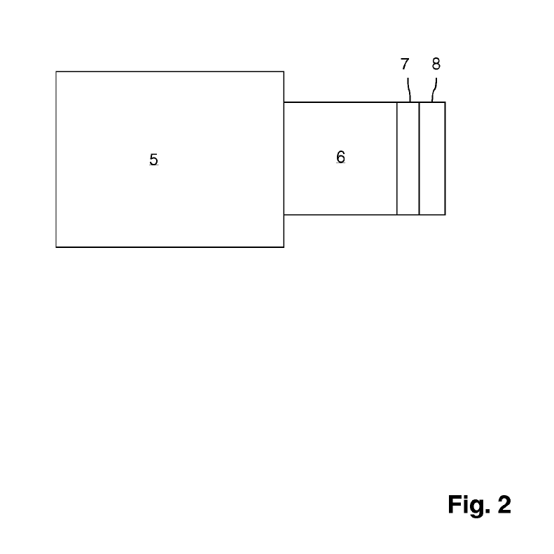

The device according to the invention furthermore includes a camera system with three individual cameras 5, shown in an exemplary fashion in FIG. 1, which can be digital cameras. Every camera 5 comprises a lens 6, an upstream band-pass filter 7 and a pole filter 8, as illustrated schematically in FIG. 2.

It is essential to the device according to the invention and to the method according to the invention that the video projector 3 has been modified or redesigned in such a way that it only emits narrowband and preferably additionally polarized light, for example by integrating a suitable laser light source.

The camera system or the individual cameras 5 are matched to the narrowband light emitted by the video projector 3 by means of the associated filter system, for example by a suitable band-pass filter 7 and a pole filter 8, in such a way that only light in the wavelength range of the light emitted by the video projector 3 can reach into the camera 5 through the filter system of the camera 5.

In respect of features which cannot be gathered from the figures, reference is made to the general part of the description in order to avoid repetition.

In order to avoid repetition, reference is made to the general part of the description and to the attached patent claims in respect of further advantageous embodiments of the device according to the invention.

Finally, reference is explicitly made to the fact that the exemplary embodiment of the device according to the invention described above merely serves to explain the claimed teaching, but does not restrict said teaching to the exemplary embodiment.

1. An apparatus for three-dimensional optical measurement of surfaces of arbitrary objects using a pattern projection method, with a projector for projecting patterns onto the surface of the object, at least one camera or imaging unit for recording the projected pattern and a computer for processing the image information recorded by the camera to form 3D data, optionally for three-dimensional imaging of the object, wherein that the projector only emits narrowband light and in that a filter apparatus is arranged in the detection beam path in front of the camera or imaging unit, which filter apparatus is only transmissive to the wavelength range of the light emitted by the projector.

2. An apparatus according to claim 1, wherein the projector is a commercially available video projector, which has been modified or redesigned for projecting narrowband light.

3. An apparatus according to claim 2, wherein the projector is equipped with a monochromatic light source, preferably a laser light source, and only emits the light from this light source.

4. An apparatus according to claim 3, wherein the monochromatic light source emits coherent light.

5-16. (canceled)

17. An apparatus according to claim 3, wherein the monochromatic light source preferably emits linearly polarized light.

18. An apparatus according to claim 2, wherein the projector does not utilize a broadband light spectrum.

19. An apparatus according to claim 1, wherein at least one of a Gaussian blur filter and a diffractive element is arranged in front of the projector.

20. An apparatus according to claim 2, wherein at least one of a Gaussian blur filter and a diffractive element is arranged in front of the projector.

21. An apparatus according to claim 1, wherein the filter apparatus associated with the camera or imaging unit comprises one or more band-pass filters.

22. An apparatus according to claim 2, wherein the filter apparatus associated with the camera or imaging unit comprises one or more band-pass filters.

23. An apparatus according to claim 1, wherein the filter apparatus comprises one or more pole filters.

24. An apparatus according to claim 2, wherein the filter apparatus comprises one or more pole filters.

25. An apparatus according to claim 1, wherein the filter apparatus comprises the combination of at least one band-pass filter and at least one pole filter.

26. An apparatus according to claim 1, wherein the filter apparatus comprises the combination of at least one band-pass filter and at least one pole filter.

27. An apparatus according to claim 1, wherein the filter apparatus is structured such that only diffusely reflected light can pass.

28. An apparatus according to claim 1, wherein the filter apparatus is structured such that it has several pass regions.

29. An apparatus according to claim 1, wherein two or more cameras or imaging units are provided.

30. An apparatus according to claim 29, wherein, with their optical axes, the cameras are aligned at different angles to the surface of the object.

31. An apparatus according to claim 1, wherein the strip light emitted by the projector can be generated by a slide, an LCD display, an LCOS display or a DLP chip.

32. A method for three-dimensional optical measurement of surfaces of arbitrary objects using a pattern projection method, the method comprising:
projecting a pattern onto the surface of the object with a projector, wherein the projector emits only narrowband light;
recording the projected pattern with at least one camera or imaging unit;
using a filter apparatus in the detection beam path in front of the camera or the imaging unit, which filter apparatus is only transmissive to the wavelength range of the light emitted by the projector; and
processing the image information recorded by the camera or the imaging unit using a computer to form 3D data;
